(19) United States
(12) Patent Application Publication
(10) Pub. No.: US 2019/0315640 A1
(43) Pub. Date: Oct. 17, 2019

(54) MEMBRANE BIO-REACTOR FOR CONDENSATE CLEANUP

(71) Applicants: Rahul D Solunke, Pearland, TX (US); Troy M Raybold, Colden, NY (US)

(72) Inventors: Rahul D Solunke, Pearland, TX (US); Troy M Raybold, Colden, NY (US)

(21) Appl. No.: 15/951,618

(22) Filed: Apr. 12, 2018

(51) Int. Cl. C02F 3/12; C01B 3/34

(52) U.S. Cl. CPC C02F 3/1268; C02F 2101/16; C01B 3/34

(57) ABSTRACT

The present invention relates to the integration of a membrane bio-reactor in a conventional hydrogen plant to remove ammonia and other organics such as methanol from the process condensate.

### BACKGROUND OF THE INVENTION

### Field of the Invention

The present invention relates to the integration of a membrane bio-reactor in a conventional hydrogen plant to remove ammonia and methanol from the process condensate. Such integration eliminates the need for significant additional capital, which otherwise must be invested for providing clean export steam to the customer. More specifically, when properly sized and integrated with the hydrogen plant, the membrane bio-reactor can reduce levels of ammonia and methanol below 1 ppmw and 10 ppmw, respectively, which meet the specifications of boiler feed water for producing high quality clean steam.

### Description of Related Art

In steam methane reforming (SMR) based hydrogen plants, ammonia and methanol are produced as byproducts in the reformer and shift reactor, respectively. Due to a high affinity of these byproducts for water at lower temperatures, majority of these byproducts leave the synthesis gas (syngas) which is predominantly hydrogen and carbon monoxide, and dissolve in the process condensate collected in the cold knockout and hot knockout drums. Both the process condensate and the heated demineralized makeup water is then deaerated to form boiler feed water. Boiler feed water is preheated and fed to the steam drum. Water from the drum circulates to one or more boilers, producing steam which exits the steam drum and may be superheated, thereby producing export and process steam streams. Such a single steam system is shown in related art FIG. 1. Much of the ammonia and methanol in the boiler feed water exit the boilers with steam. About 45% of the steam produced in the boilers is sold to the customer as export steam. Due to customer's increasing use of new generation high efficiency steam turbines, which are less tolerant to steam contaminants, high levels of ammonia and methanol in the export steam are not acceptable.

SMR based hydrogen plants typically utilize excess heat in flue gas and syngas to drive the boilers which produce steam that is exported to the customer. For instance, a large 100 million standard cubic feet per day (MMSCFD) hydrogen plant produces about 45 lb of export steam per KSCFH of hydrogen. Of the total steam produced, about 45% is exported to the customer and the rest is consumed in the reformer as process steam. The sale of export steam lowers the total variable cost of hydrogen by about 15%. Customers often use some or all of the steam to produce power in a steam turbine. Steam turbines are becoming increasingly efficient with advancements in component materials, making them increasingly intolerant to contaminants in steam. Therefore, customers have very stringent specifications for export steam. A typical customer specification, largely based on American Society of Mechanical Engineers (ASME) standard (CRTD Vol. 34 and Vol. 35), for 650 psig high quality saturated steam is, as shown in Table 1 below.

TABLE 1
High Quality Clean Steam Specification

| Contaminant/Parameter | Units | Specification |
|---|---|---|
| Total Dissolved Solids | ppbw | <100 |
| Silica as SiO2 | ppbw | <20 |
| Sodium plus Potassium | ppbw | <20 |
| Total Iron as Fe | ppbw | <20 |
| Total Copper as Cu | ppbw | <3 |
| Chloride as Cl | ppbw | <5 |
| Ammonia as N | ppmw | <0.5 |
| Methanol | ppmw | <10 |
| pH at 25° C. | — | 8.5-9.2 |

Based on the total water consumption for producing steam, about 75% originates as makeup water and about 25% comes from recycled process condensate. Makeup water is the raw water which comes from nearby lakes, rivers or municipal water supplies. This water contains silica, metal ions, chlorides, sulfates, dissolved and suspended solids and dissolved oxygen. These contaminants are removed using Reverse Osmosis followed by Ion Exchange polishing. Dissolved oxygen is removed in the deaerator by stripping followed by using oxygen scavenger chemicals. The process condensate is the condensate obtained when hot syngas is cooled. It is usually collected in the hot and cold water knock out drums. Syngas contains small amounts of ammonia and methanol which are produced in the reformer and shift reactor, respectively. In addition, ethanol and trace levels of organic acids like formic acid and acetic acid are also produced in the shift reactor. Production of these byproducts is favored at lower temperature and hence gets more pronounced in medium and low temperature shift reactors. Besides temperature, catalyst age also plays a major role in the level of contaminants produced. Fresh catalyst produces higher levels of contaminants due to its higher activity. The majority of the ammonia, methanol, ethanol and organic acids remain in the process condensate during the condensation process. Related art systems, such as reverse osmosis, ion exchange and deaeration, which are discussed below, cannot efficiently remove the contaminants in the process condensate. To address this issue, plants are typically designed with segregated steam systems, such as the one shown in FIG. 2, where low quality steam produced from the process condensate is entirely utilized in the reformer as process steam and high quality steam produced from the makeup water is the only source of export steam sold to the customer. Such segregation of different quality of steam streams requires duplication of multiple pieces of equipment which increases the plant cost about 5-10% more than the conventional single steam system design.

The related art proposes certain systems for removing ammonia and organic compounds from process condensate. For example U. S. Patent Application Publication No. 2012/0273355 A1 to Frakas et al. discloses the use of an electrodeionization (EDI) technique for removal of ammonia from water. EDI relies on dissociation of ammonia in water and then removal of ammonium ion by applying electric field. However, EDI cannot remove compounds which do not dissociate in water. This includes methanol and ethanol. For the removal of such alcohols they must first be converted to organic acids which can dissociate in water. However, organic acids dissociation in water is very weak and hence the removal efficiency is very low. EDI technologies sold by major suppliers like GE require total organic content (TOC) of water to be less than 0.5 mg/l. TOC in process condensate of hydrogen plants can be as high as 40 mg/l, thereby making EDI only a polishing step.

European Patent Application No. 1 803 689 A1 to Provera et al. focuses on cleaning waste waters in power plant. This document mainly deals with total recovery of the waste water while consuming minimum energy. It uses a bioreactor to consume contaminants in the waste water. However, it does not specifically use the membrane bio-reactor and, moreover, it does not make any reference to the process condensate cleanup in syngas plants.

U. S. Patent Application Publication No. 2007/0209999 A1 to Smith et al., as well as U.S. Pat. No. 7,118,672 B2 to Jordan et al and U.S. Pat. No. 6,805,806 B2 to Arnaud, specifically discuss the use of membrane bio-reactor to treat industrial waste water. The patent documents discuss the design of a membrane bio-reactor and its advantages over the then conventional activated sludge type of bio-reactors. Even though the documents directly discuss the use of bio-reactor, they do not mention its use for the process condensate cleanup in hydrogen or syngas production plants. Moreover, these documents do not address the need for efficient integration with the syngas plant in order to minimize the capital and operating costs.

In Process Condensate Purification in Ammonia Plants, Ammonia Plant Safety, Vol. 31, the report discloses the use of steam strippers to clean the process condensate in ammonia production plants. The impurities in the process condensate in ammonia plants are essentially similar to those observed in the process condensate of hydrogen or syngas production plants. For this reason, steam strippers can also be used in hydrogen or syngas production plants. However, steam strippers are energy intensive and difficult to control at turndown production rates. Moreover, they are prone to channeling, fouling, plugging and foaming which may lead to poor efficiencies. They are also difficult to inspect and clean.

Therefore, it remains desirable to use alternative and less expensive process condensate cleanup techniques which can enable the use of low cost single steam plant designs while meeting the high quality clean export steam specifications.

To address some of the issues encountered in the related art, the present invention proposes integrating membrane bio-reactors in hydrogen and syngas production plants. The MBRs are not energy intensive, may be operated at turndown rates with good control, and they do not have any operational issues which may significantly reduce the efficiency of the process. In addition, they are easier to inspect and clean.

Further, the chemistry of process condensate in syngas plants can be very different than that of waste water in power plants. In the process of the present invention the membrane bio-reactor for condensate cleanup relies on principles of aerobic digestion of ammonia and organic matter by the living organisms and therefore it is more suitable for the bulk removal of contaminants.

Other objects and aspects of the present invention will become apparent to one of ordinary skill in the art upon review of the specification, drawings and claims appended hereto.

### SUMMARY OF THE INVENTION

According to an aspect of the invention, a process for cleaning a process condensate from a synthesis gas or hydrogen production plant is provided.

The process includes:

processing a hydrocarbon feedstock in a reactor to produce a synthesis gas and at least one stream of contaminated process condensate;

introducing the contaminated process condensate into a membrane bio-reactor integrated with a single steam system of the plant, wherein high levels of organic contaminants and ammonia are removed; and routing a clean process condensate from the membrane bio-reactor to produce an export steam in a single steam system of the synthesis gas or hydrogen production plant, wherein the export steam produced is derived at least in part from said clean process condensate.

In another aspect of the invention, a process for cleaning a process condensate from a synthesis gas or hydrogen production plant is provided. The process includes:

processing a hydrocarbon feedstock in a reactor to produce a synthesis gas and at least one stream of contaminated process condensate;

introducing the contaminated process condensate into a membrane bio-reactor integrated with a single steam system of the plant, wherein high levels of organic contaminants and ammonia are removed; and routing a clean process condensate from the membrane bio-reactor to one or more process operation units in the single steam system of the synthesis or the hydrogen production plant to produce an export steam.

In accordance with yet another aspect of the invention, a process for cleaning a process condensate from a synthesis gas or hydrogen production plant is provided. The process includes:

processing a hydrocarbon feedstock in a reactor to produce a synthesis gas and at least one stream of contaminated process condensate;

introducing the contaminated process condensate into a membrane bio-reactor integrated with a single steam system of the plant, wherein high levels of organic contaminants and ammonia are removed; and heating a clean process condensate from the membrane bio-reactor to produce an export steam in a single steam a system of the synthesis gas or hydrogen production plant.

### BRIEF DESCRIPTION OF THE FIGURES

The objects and advantages of the invention will be better understood from the following detailed description of the preferred embodiments thereof in connection with the accompanying figures wherein like numbers denote same features throughout and wherein:

FIG. 1 is a process flow diagram of a related art single steam system associated with a hydrogen or syngas production plant;

FIG. 2 is a process flow diagram of a related art segregated/dual steam system associated with a hydrogen or syngas production plant;

FIG. 3 is a schematic of an integrated MBR with hydrogen or syngas production plant in accordance with one exemplary embodiment of the invention;

FIG. 4 illustrates a schematic of an integrated MBR with hydrogen or syngas production plant in accordance with another exemplary embodiment of the invention;

FIG. 5 depicts a schematic of an integrated MBR with hydrogen or syngas production plant in accordance with a further exemplary embodiment of the invention;

FIG. 6 illustrates a schematic of an integrated MBR with hydrogen or syngas production plant in accordance with yet another exemplary embodiment of the invention; and

FIG. 7 a schematic of an integrated MBR with hydrogen or syngas production plant in accordance with a further exemplary embodiment of the invention.

### DETAILED DESCRIPTION OF THE INVENTION

The present invention provides for the removal of contaminant byproducts in a syngas or hydrogen plant through the various exemplary embodiments where a membrane bio-reactor (MBR) is integrated with the syngas or hydrogen production plant in order to produce a high quality export steam in a single steam plant design. A hydrocarbon feedstock is reacted in a steam reformer, autothermal reformer or partial oxidation reactor to form syngas, which can be further reacted and/or purified to form hydrogen.

An MBR uses live organisms in the bio-reactor to consume ammonia and organic matter including methanol, ethanol and organic acids such as formic acid and acetic acid for their growth. The MBR process consists of a suspended growth biological reactor integrated with a membrane filtration system. The MBR works on the principle of aerobic digestion. This requires use of air blowers to feed air to the bio-reactor tank. Overflow from the MBR is sent to the membrane separation unit which separates solids (bio-sludge) from the clean water. Bio-sludge, which is about 2% solids, is then recycled back to the bio-reactor. Part of this recycle is continuously discarded. This discard stream is thickened into bio-cakes using a bio-sludge thickening process. MBRs are widely employed in wastewater treatment which contains far more complex contaminants than those present in the process condensate. Several water cleanup companies including GE and Siemens have deployed this technology at numerous waste water treatment sites worldwide.

In the present invention, the MBR is employed to remove the aforementioned contaminants, and particularly ammonia and methanol from the process condensate in syngas plant. For the purpose of this description, the plant produces hydrogen by reacting natural gas in a steam reformer. However, it will be recognized by those skilled in the art that the hydrogen plant could also be an auto thermal reformer or a partial oxidation reformer based plant.

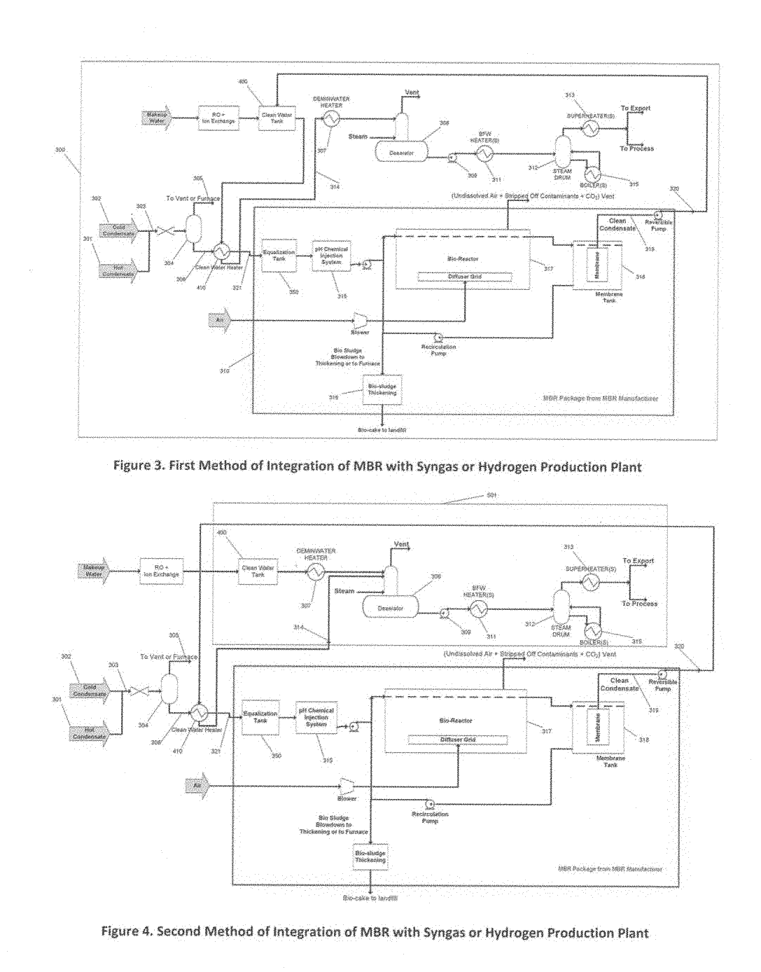

With reference to FIG. 3, an exemplary embodiment of the invention is provided where the MBR 310 is integrated with the hydrogen plant water/steam system 300. In this method, hot and cold contaminated condensate streams 301 and 302 are mixed together. The pressure of the mixed condensate stream 303 is dropped from about 200-500 psig to about 0-60 psig and then the mixed contaminated condensate is fed to a flash drum 304. Flash drum 304 operates at a pressure of about 0 psig to 60 psig and removes about 40-80% of the CO₂ present in the mixed contaminated condensate which leaves the flash drum in the vapor stream 305. This vapor stream can be either vented or sent to the flue gas duct of the furnace depending on the environmental regulations. Such integration can substantially reduce consumption of pH adjustment chemicals which are added by the pH chemical injection system to the condensate prior to the treatment in the MBR. Contaminated liquid stream condensate 306 exiting the flash drum 304 would need to be cooled to suit bio-reactor 317 inlet operating temperature. The living organism in the bio-reactor consumes ammonia and organic compounds such as methanol, ethanol and organic acids. To improve efficiency, this can be done by heating the clean water from the clean water tank 400 against the heat from the contaminated liquid condensate stream 306 coming out of the flash drum 304. Heated clean water 314 is then fed to the sequence of process operation units such as the demineralized water heater 307, deaerator 308, boiler feed water pump 309, boiler feed water heater 311, boiler 315, steam drum 312 and steam superheater 313. Steam at the exit of the steam superheater is quite pure, having less than 0.5 ppmw ammonia and less than 10 ppmw methanol and can be directly exported to the customer.

Typically, the temperature of the stream fed to the MBR as liquid condensate stream 321 can vary in temperature from a range of about 32° F. to 130° F., preferably 50° F. to 130° F. For typical systems, the flow of stream 321 ranges from 50-300 gpm. In typical MBR configurations, the equipment is a sequence of different unit operation and the number of different units shown in FIG. 3 is typically prescribed by the MBR manufacturer. For instance, it may include an equalization tank 350, a pH injection system 315 and a bio-sludge thickening system 316 as prescribed by the MBR manufacturer. The membrane bio-reactor operates at pressures ranging from about 10 to 35 psia.

In the operation of the MBR 310, the equalization tank 350 is used to suppress fluctuations in a portion of the liquid stream condensate's flow, temperature and contaminant levels. pH chemical injection system 315 is employed to raise the pH of the mixed condensate from about 6 to 10. The bio-reactor 317 has biomass specifically grown to consume ammonia and organic compounds. This reactor is aerated by ambient air to supply oxygen to biomass. Biomass sludge from bio-reactor 317 is sent to a membrane 318 to separate biomass from clean water. Concentrated biomass sludge from the membrane is recycled back to the bio-reactor 317. The process also has a biomass blowdown to maintain biomass concentration in the bio-reactor. Vent from the bio-reactor is directly sent to the atmosphere or routed to the flue gas duct of the furnace in order to meet the environmental regulations. Bio sludge blowdown from the bio reactor 317 is fed to the bio sludge thickening process which thickens the sludge to make solid cakes, which can then be sent to the landfill. Alternatively, bio sludge can be routed to the flue gas duct of the furnace where it is incinerated at high temperature. Without being limited to a particular theory, it is believed that bio-reactor 317 consumes ammonia and organic compounds like methanol, ethanol and organic acids from the liquid condensate stream 321 entering equalization tank 350. The bio-sludge inside the bioreactor 317 contains living organisms (i.e., solids) and clean condensate (i.e., liquid). The clean condensate stream 320 is routed to the clean water tank 400, where it can be combined with clean make-up water in this embodiment.

In another exemplary embodiment, and as shown in FIG. 4, instead of sending the clean condensate 320 to the clean water tank 400, it is sent directly to the clean water heater 410 upstream of the MBR 310. Subsequent to heating in the clean water heater 410, clean condensate 314 is sent to the stripping section 420 of the deaerator 308. This type of configuration reduces the load on the clean water tank pump (not shown) and the demin water heater 307 thus potentially enabling additional operating cost savings.

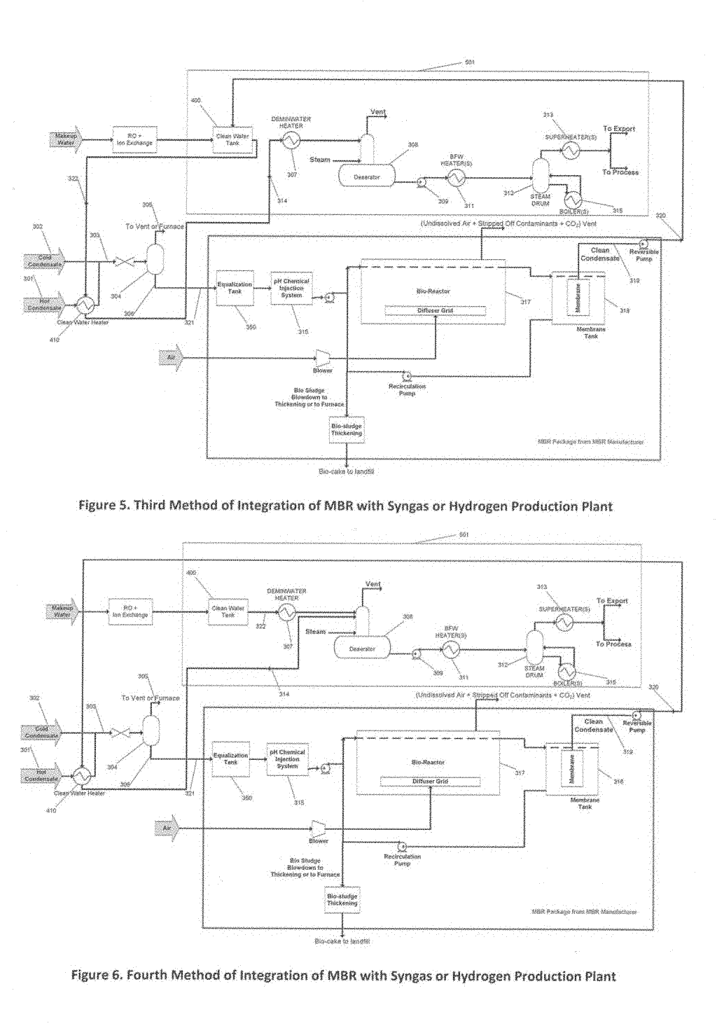

With reference to FIG. 5, another exemplary embodiment is depicted where the hot condensate stream 301 is cooled by clean water 322 from the clean water tank 400 prior to mixing with the cold condensate stream 302. The mixed contaminated condensate stream 303 is routed into the flash drum 304. This configuration maximizes heating of the clean water stream 322 from the clean water tank 400 and thus reduces the load on the demineralized water heater 307 in the single steam train/system 501.

Turning to FIG. 6, the configuration of the integration is similar to that of FIG. 4, except for the hot condensate stream 301 is cooled by clean condensate 320 prior to mixing with the cold condensate stream 302. This configuration maximizes heating of the clean condensate stream and thus reduces the load on the demineralized water heater 307.

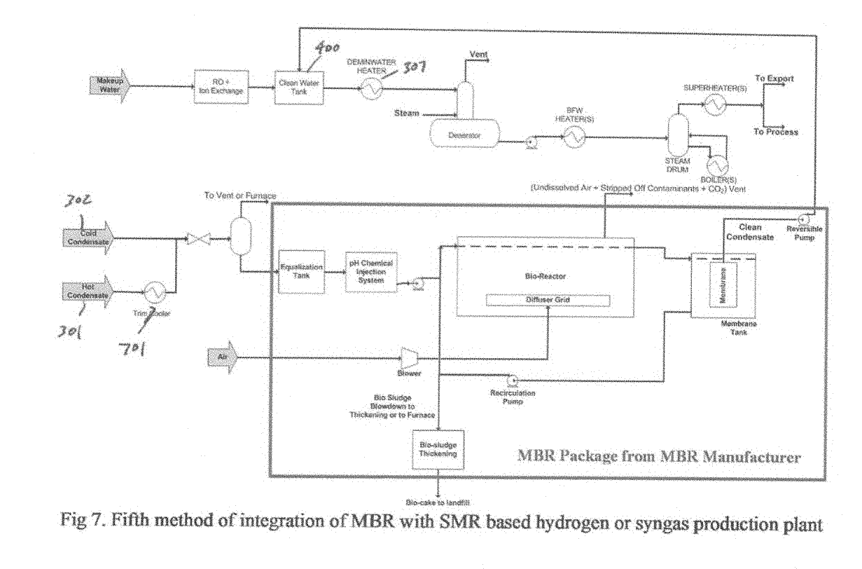

As depicted in FIG. 7, another system integration of an MBR 310 with hydrogen or syngas production plant 300 is provided. It has same configuration as shown in FIG. 5 except hot condensate stream 301 is cooled in a trim water cooler 701. This type of configuration may be used when no heat sink is available to take advantage of the low grade heat in the hot condensate stream 301. The trim cooler, for instances, utilizes water received from a cooling tower (not shown) to reduce the temperature of hot condensate stream 301, such that the the mixed condensate stream 303 is at a temperature suitable for MBR 310.

The following Comparative Example, provides the advantages of the present invention.

### Comparative Example

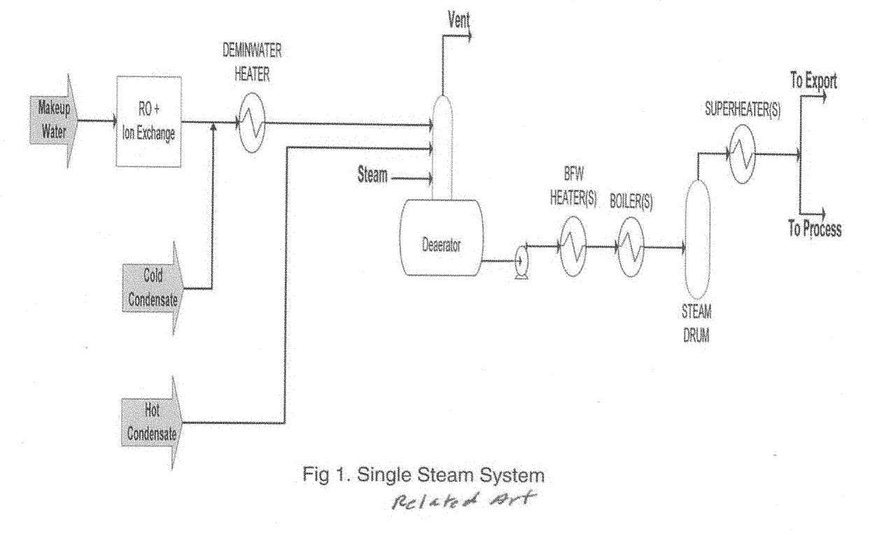

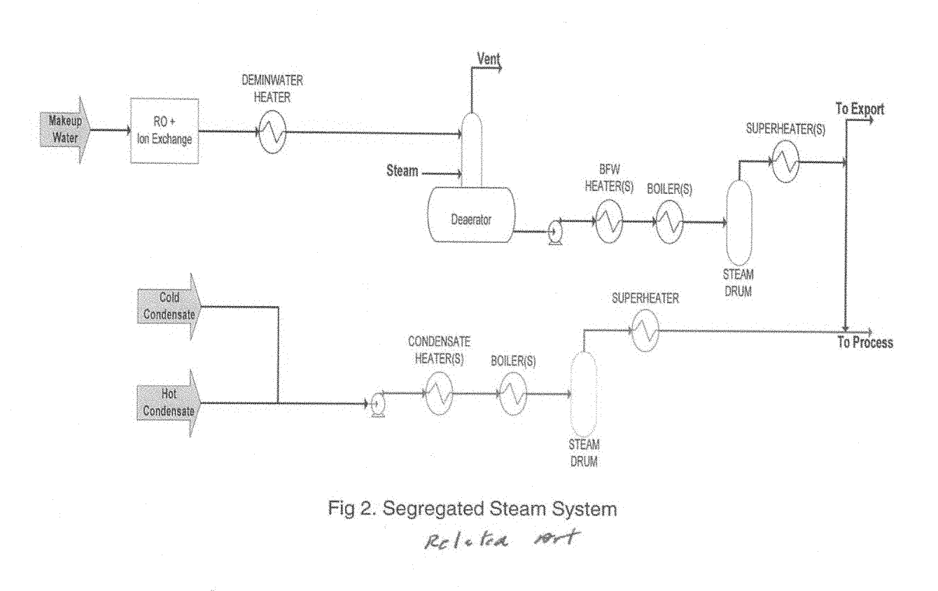

Process simulations were carried out for the base case in accordance with the embodiment of the related art shown in FIG. 1 and one method of integrating MBR with SMR based hydrogen production plant as shown in the embodiment ofFIG. 3 in the present invention. Table 2 shows the comparison between the two cases. Based on the comparison, MBR integration is capable of reducing the ammonia and methanol in export steam to very low levels in order to meet the high quality export steam specifications.

TABLE 2
Comparison Between Related Art and One
Configuration of Present Invention

| | | Base Case | MBR Case |
|---|---|---|---|
| | Unit | (FIG. 1) | (FIG. 3) |
| Hydrogen Production | MMSCFD | 118 | 118 |
| Cold Condensate Flow | GPM | 66 | 67 |
| Hot Condensate Flow | GPM | 181 | 180 |
| Ammonia in Cold | ppmw | 1088 | 1098 |
| Condensate | | | |
| Methanol in Cold | ppmw | 985 | 976 |
| Condensate | | | |
| Ammonia in Hot | ppmw | 698 | 691 |
| Condensate | | | |
| Methanol in Hot | ppmw | 142 | 140 |
| Condensate | | | |
| Ammonia in Export Steam | ppmw | 210 | <0.5 |
| Methanol in Export Steam | ppmw | 96 | <10 |

Thus, as can be seen in the present invention the ammonia and methanol contaminants are reduced to below 0.5 and 10 ppmw, respectively, as compared to the base case.

While the invention has been described in detail with reference to specific embodiments thereof, it will become apparent to one skilled in the art that various changes and modifications can be made, and equivalents employed, without departing from the scope of the appended claims.

What is claimed is:

1. A process for cleaning a process condensate from a synthesis gas or hydrogen production plant, comprising:
processing a hydrocarbon feedstock in a reactor to produce a synthesis gas and at least one stream of contaminated process condensate;
introducing the contaminated process condensate into a membrane bio-reactor integrated with a single steam system of the plant, wherein high levels of organic contaminants and ammonia are removed; and
routing a clean process condensate from the membrane bio-reactor to produce an export steam in a single steam system of the synthesis gas or hydrogen production plant, wherein the export steam produced is derived at least in part from said clean process condensate.

2. The process of claim 1, further comprising routing the clean process condensate through a clean water heater thereby reducing the temperature of the contaminated process condensate to a temperature ranging from about 60° F. to about 130° F. prior to introducing it into the membrane bio-reactor.

3. The process of claim 1, wherein a stream of cold contaminated process condensate is mixed with a stream of hot contaminated process condensate forming a contaminated process condensate and routing same to a flash drum and removing about 40 to 80 percent of the carbon dioxide prior to routing the contaminated process condensate to the membrane bio-reactor.

4. The process of claim 3, further comprising routing the contaminated condensate stream from the flash drum to a cold water heater where the clean process condensate is employed to lower the temperature of the contaminated process condensate prior to introducing it into the membrane bio-reactor.

5. The process of claim 1, wherein the synthesis or hydrogen production plant includes a reactor that is a steam methane reformer, an auto-thermal reformer or a partial oxidation unit.

6. The process of claim 1, wherein the membrane bio-reactor operates at pressures ranging from about 10 to 35 psia.

7. The process of claim 1, wherein the clean process condensate stream is routed to a stripping section of a deaerator of the single steam system in the synthesis gas or hydrogen production plant.

8. The process of claim 1, wherein the clean process condensate stream is mixed with make-up water in the clean water tank and routed to a demineralized water heater of the single steam system in the synthesis gas or hydrogen production plant.

9. The process of claim 3, wherein the clean process condensate stream is routed to the clean water heater where it cools the contaminated hot condensate stream and is further routed to a demineralized water heater of the single steam system in the synthesis gas or hydrogen production plant.

10. The process of claim 3, wherein the contaminated hot condensate stream is routed to a trim water cooler prior to mixing with the contaminated cold condensate stream.

11. The process of claim 1, wherein the contaminants removed from the clean condensate stream are selected from the group comprising ammonia, methanol and other organic compounds.

12. The process of claim 1, wherein the export steam is high quality having less than 0.5 ppmw ammonia and less than 10 ppmw methanol.

13. A process for cleaning a process condensate from a synthesis gas or hydrogen production plant, comprising:
processing a hydrocarbon feedstock in a reactor to produce a synthesis gas and at least one stream of contaminated process condensate;
introducing the contaminated process condensate into a membrane bio-reactor integrated with a single steam system of the plant, wherein high levels of organic contaminants and ammonia are removed; and
heating a clean process condensate from the membrane bio-reactor to produce an export steam in a single steam system of the synthesis gas or hydrogen production plant.

14. A process for cleaning a process condensate from a synthesis gas or hydrogen production plant, comprising:
processing a hydrocarbon feedstock in a reactor to produce a synthesis gas and at least one stream of contaminated process condensate;
introducing the contaminated process condensate into a membrane bio-reactor integrated with a single steam system of the plant, wherein high levels of organic contaminants and ammonia are removed; and
routing a clean process condensate from the membrane bio-reactor to one or more process operation units in the single steam system of the synthesis or the hydrogen production plant to produce an export steam.
